(19) United States
(12) Patent Application Publication
(10) Pub. No.: US 2014/0320025 A1
(43) Pub. Date: Oct. 30, 2014

(54) ROAD ILLUMINATION SYSTEM

(71) Applicant: Daniel ASSOULIN, Givat Zeev (IL)

(72) Inventor: Daniel Assoulin, Givat Zeev (IL)

(21) Appl. No.: 14/366,526

(22) PCT Filed: Dec. 19, 2012
(86) PCT No.: PCT/IL2012/050535

§ 371 Date: Jun. 18, 2014

(30) Foreign Application Priority Data
Dec. 19, 2011 (GB) 1121769.2

(51) Int. Cl. H05B 33/08; H05B 37/02

(52) U.S. Cl. CPC H05B 33/0842; H05B 37/02
USPC 315/154

(57) ABSTRACT

A road illumination system having sensors detecting approaching vehicles and operating thereupon and via a controller switches associated with street lights is provided herein. The system turns street lights off when no vehicles are present and spares thereby electricity. The system activates the street lights groupwise, to supply enough illumination with a minimal amount and complexity of equipment. The system further has an extended ability to identify malfunctioning and exceptional situations, in which is activates the street lights continuously. The system is a distributed wireless one, and may be configured remotely.

### BACKGROUND

1. Technical Field The present invention relates to the field of energy saving, and more particularly, to saving illumination energy.

2. Discussion of Related Art

Many street lamps are activated at dark time all night long. Many roads are not lighted because of high price of electricity and too thin traffic that make it unworthy.

Prior art documents, such as GB 2,444,734, GB 2,455,504, BE 1,009,084, EP 2,271,184, JP 6,096,865 and US 2010/148,696 disclose various systems that aim at saving illumination energy along streets, but these systems are elaborate, expensive and sensitive to failures which may result in considerable traffic hazards.

### BRIEF SUMMARY

One aspect of the present invention provides a road illumination system comprising: at least one sensor arranged to detect an approaching vehicle on a road, a plurality of switches, each associated with a street light and arranged to switch the street light on and off, a controller arranged to receive a vehicle detection from the at least one sensor and activate, via a communication link, switches associated with a specified group of street lights for a specified period, wherein an activation speed is higher than a maximal vehicle speed, wherein the specified group comprises at least the street lights within a shorter distance between one kilometer ahead of the vehicle, and a distance between the vehicle and the vehicle's horizon; and the specified period is at least an estimated travelling period across the specified group of street lights, wherein the switch is arranged to switch the associated street light off after a specified period in which no activation signal is received from the controller, and wherein each switch is further arranged to switch the associated street light constantly on upon detection of malfunctioning of the communication link.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1-3 are high level schematic illustrations of various configurations of a road illumination system according to some embodiments of the invention, and

FIG. 4 is a high level flowchart illustrating a road illumination method, according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

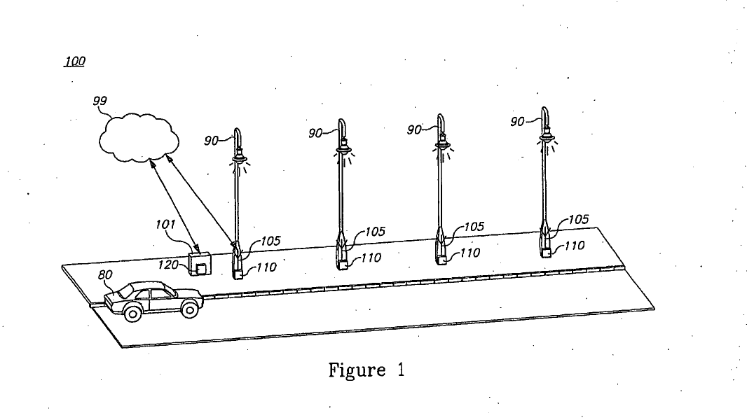

FIGS. 1-3 are high level schematic illustrations of various configurations of a road illumination system 100 according to some embodiments of the invention.

Road illumination system 100 comprises at least, one sensor 120 arranged to detect an approaching vehicle 80 on a road and a plurality of switches 110, each associated with a street light 90 and arranged to switch the street light 90 on and off.

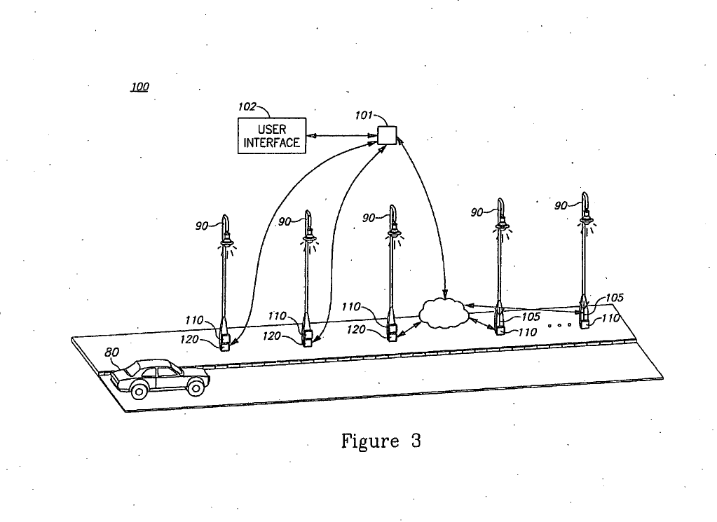

Road illumination system 100 further comprises a controller 101 arranged to receive a vehicle detection from the at least one sensor 120 and activate, via a communication link 99, switches 110 associated with a specified group 91 of street lights 90 for a specified period, wherein an activation speed is higher than a maximal vehicle speed, e.g. at a rate higher than 5 km per second or even higher than 30 m in 6 msec. Switches 110 may receive the activation signals via antennas 105 from communication link 99. The configuration of communication link 99 may depend on the road and terrain conditions, as well as on the distribution of sensors 120 and controllers 101 (see FIG. 3 for some examples).

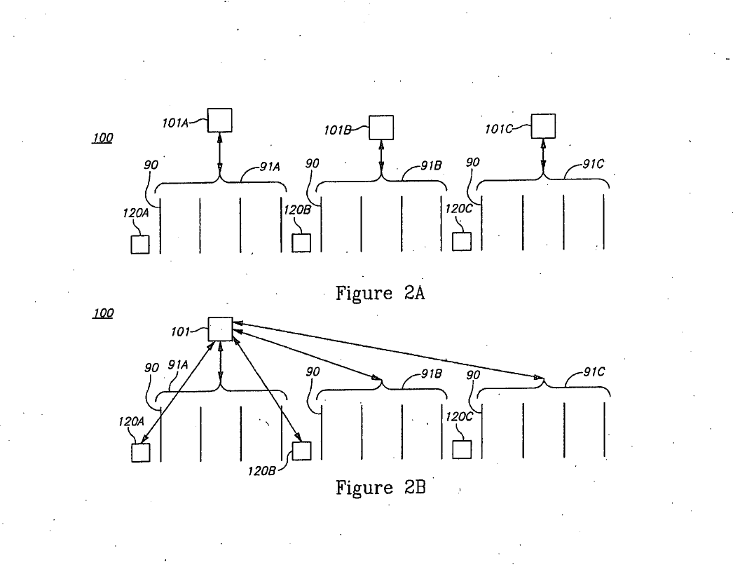

Sensors 120 may be associated with each street light 90 (see left part of FIG. 3), with some of street lights 90 (see right part of FIG. 3), may be independent of any specific street light 90 (see FIG. 2B), or may associated with controller 101 (see FIG. 1). All street lights 90 may be associated with switch 110, or some of street lights 90 may be . outside system 100 and illuminate constantly as a safety measure.

Sensors 120 may be arranged to only detect passing vehicles 80 or may be arranged to gather information about vehicles 80 such as speed, number or density. Sensors 120 may be arranged to detect standing (or stuck) vehicles 80. For example, a detection distance of sensor 120 may be ten meters.

The specified group 91 comprises at least the street lights 90 within a shorter distance between one kilometer ahead of the vehicle 80, and a distance between the vehicle 80 and the vehicle's horizon; and the specified period is at least an estimated travelling period across the specified group 91 of street lights 90. Generally, the distance is configured to allow enough driving time to light up street light 90.

Switch 110 is arranged to switch the associated street light 90 off after a specified period in which no activation signal is received from the controller 101. Controller 101 may be arranged to switch off street lights 90 singly or groupwise (groups 91A, 91B, 91C in FIGS. 2A and 2B) after a period with no passing vehicles, or a certain estimated distance after the last vehicle 80 has passed (e.g. 300 m). Alternatively, switches 120 may be arranged to switch associated street light 90 after a certain period in which no further activation signal from controller 101 has been received.

Each switch 110 is further arranged to switch the associated street light 90 constantly on upon detection of malfunctioning of communication link 99. For example, controller 101 may send a control signal every predefined period, and switch 110 not receiving this signal may switch the associated street light 90 constantly on.

Sensors 120 may be arranged in pairs, each having a first sensor 120A and a consecutive second sensor 120B (FIG. 2A and 2B). Sensors pairs may be sequential, i.e. a next sensor pair may comprise sensor 120B as the first sensor and sensor 120 C as the second sensor.

Controller 101 is arranged to identify a detection error of first sensor 120A by receiving a detection from second sensor 120B without prior detection by the first sensor 120A, and further arranged to activate street lights 90 positioned between first and second sensors 120A, 120B respectively, via the respective switches 110, continuously.

System 100 may comprise a single controller 101 communicating with several street light groups (groups 91A, 91B, 91C) as illustrated in FIG. 2B, or system 100 may comprise several controllers 101A, 101B, 101C, each associated with group 91A, 91B, 91C respectively, and optionally also with sensor 120A, 120B, 120C respectively, as illustrated in FIG. 2A.

System 100 may support the further exceptional conditions: (i) Override—constant activation of street lights 90, (ii) failure of sensor 120—constant activation of street lights 90 in the respective segment (e.g. group 91A in case of failure of sensor 120A), (iii) combination of groups in case of failure of an intermediate sensor 120 (e.g. uniting groups 91A and 91B in case of failure of sensor 120B, with adaptation of the specified activation period), and (iv) a stuck vehicle 80, identified directly by sensor 120 or by a comparison of the number of vehicles passing between sensors 120 (e.g. between sensors 120B and 120C). In this case corresponding street lights 80 may be activated continuously.

Advantageously, system 100 is designed to enable switching off street lights 90 whenever there is enough separation between road traffic to efficiency save energy. For example, in a road segment of 10 km with 300 street lights 90 positioned 30 m apart, carrying lean traffic, system 100 may allow switching off lights averaging at 4 hours a night, saving ca. 300 kWh per night. The savings can be especially high in case of street lights 90 using LED arrays for illumination.

Regarding street lights 90 in proximity of sensors 120, these would preferably be LED lamps, as they have a short period for turning on. For example, a specified number of street lights 90 after sensor 120 may be LED lamps. The specified number may be 1, 3, 5 or 10, depending on expected vehicle velocity, road conditions and illumination intensity. Specific types of lamps may be selected according to the respective position of respective street light 90 and gathered statistics.

System 100's activation of street light groups 91 is more effective as a passing vehicle requires long range illumination and is more cost effective in sparing sensors and controllers 101.

Systems 100 may further comprise a user interface 102 (FIG. 3), either embedded in controller 101 or connecting to controller 101 via the Internet, that allows configuring the parameters of the usage scenario, from sensing sensitivity to partial lighting (switch off some of the street lights).

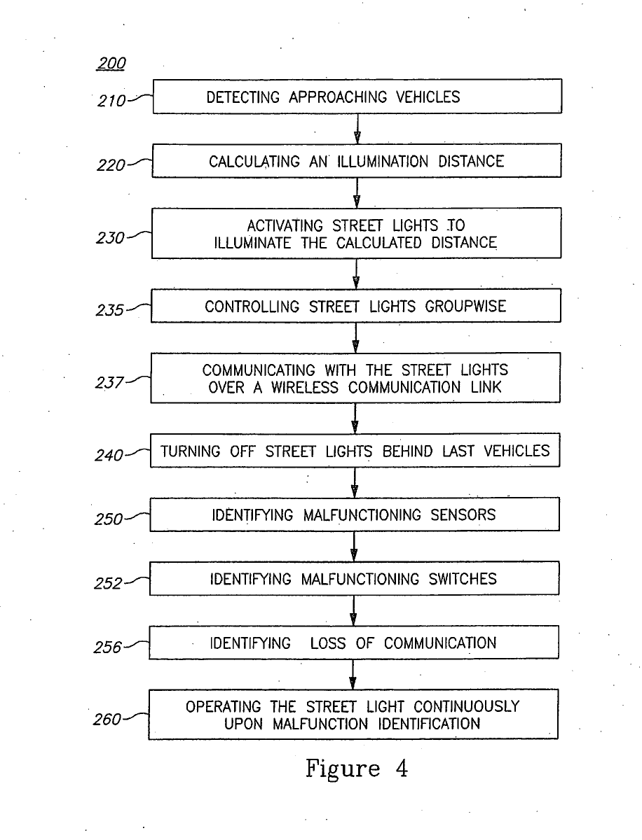

FIG. 4 is a high level flowchart illustrating a road illumination method 200 according to some embodiments of the invention.

Road illumination method 200 comprises the following stages: detecting approaching vehicles (stage 210), calculating an illumination distance (stage 220), activating street lights to illuminate the calculated distance (stage 230), controlling street lights groupwise (stage 235), turning off street lights behind last vehicles (stage 240), identifying loss of communication (stage 256), and operating the street light continuously upon malfunction identification (stage 260).

Activating street lights (stage 230) may be carried out by communicating with the street lights via a wireless communication link (stage 237).

Road illumination method 200 may further comprise identifying malfunctioning sensors (stage 250) and identifying malfunctioning switches (stage 252), and operating the street light continuously upon malfunction identification (stage 260).

Malfunction identification (stage 260) may comprise a loss of communication, a malfunctioning of detection stage 210, identification of a standing vehicle etc.

Road illumination method 200 may further comprise configuring parameters in association with a usage scenario of method 200.

Advantageously, the communication between one or more of the sensors and the switched may be carried out by a hop-by-hop transport thereby implementing a distributed communication system that enjoys unlimited range and more robustness.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

1. A road illumination system comprising:
at least one sensor arranged to detect an approaching vehicle on a road;
a plurality of switches, each associated with a street light and arranged to switch the street light on and off; and
a controller arranged to receive a vehicle detection from the at least one sensor and activate, via a communication link, switches associated with a specified group of street lights for a specified period, wherein an activation speed is higher than a maximal vehicle speed,
wherein the specified group comprises at least the street lights within the shorter of: the distance of one kilometer ahead of the vehicle; and the distance between the vehicle and the vehicle's horizon, and the specified period is at least an estimated travelling period across the specified group of street lights,
wherein each switch is arranged to switch off its associated street light, after a specified period in which no activation signal is received from the controller, and
wherein each switch is further arranged to switch on constantly its associated street light, upon detection of malfunctioning of the communication link.

2. The road illumination system of claim 1, wherein:
the at least one sensor comprises at least one pair of a first sensor and a consecutive second sensor,
the controller is further arranged to identify a detection error of the first sensor by receiving a detection from the second sensor without prior detection by the first sensor, and
the controller is further arranged to activate the street lights positioned between the first and the second sensors, via the respective switches, continuously.

3. The road illumination system of claim 1, wherein the controller is arranged to switch off street lights singly or groupwise after a period with no passing vehicles or a specified distance after the last vehicle has passed.

4. The road illumination system of claim 1, further comprising a user interface communicating with and allowing configuration of the controller.

5. The road illumination system of claim 1, wherein a specified number of street lights after each sensor use LED lamps.

6. The road illumination system of claim 1, wherein the communication link comprises a hop-by-hop distributed communication link between one or more of the sensors and the switches.

7. A road illumination method comprising:
detecting approaching vehicles,
calculating an illumination distance,
activating street lights to illuminate the calculated distance,
controlling street lights groupwise,
turning off street lights behind last vehicles,
identifying loss of communication, and
operating the street light continuously upon malfunction identification.

8. The method of claim 7, wherein the activating is carried out by communicating with the street lights via a wireless communication link.

9. The method of claim 7, further comprising identifying malfunctioning sensors and identifying malfunctioning switches, and operating the street light continuously upon malfunction identification.
